(19) United States
(12) Patent Application Publication
(10) Pub. No.: US 2019/0376566 A1
(43) Pub. Date: Dec. 12, 2019

(54) DRIVE FORCE DISTRIBUTION APPARATUS

(71) Applicant: JTEKT CORPORATION, Osaka-shi (JP)

(72) Inventors: Yuji TSUZUKI, Chiryu-shi (JP); Mikiharu OYABU, Chiryu-shi (JP); Yoshinori SUZUKI, Okazaki-shi (JP); Shun OHNO, Anjo-shi (JP); Hiroyuki INOUE, Anjo-shi (JP); Naoki OOTAWARA, Kariya-shi (JP)

(73) Assignee: JTEKT CORPORATION, Osaka-shi (JP)

(21) Appl. No.: 16/432,427

(22) Filed: Jun. 5, 2019

(30) Foreign Application Priority Data
Jun. 7, 2018 (JP) 2018-109742

(51) Int. Cl. F16D 21/06; B60K 17/02; F16D 13/64; F16D 13/68; F16D 13/52; F16H 48/19; F16D 25/10

(52) U.S. Cl. CPC F16D 21/06; B60K 17/02; F16D 13/648; F16D 13/683; B60K 17/344; F16H 48/19; F16D 25/10; F16D 2021/0661; F16D 13/52

(57) ABSTRACT

A drive force distribution apparatus includes a clutch housing, first and second multi-plate clutches, and a center plate located between the first and second multi-plate clutches. The clutch housing includes a body member having a cylindrical portion and a bottom portion, and a tubular fixation member fixed to part of the cylindrical portion close to an open end. The cylindrical portion of the body member includes a first fit portion to which the first multi-plate clutch is fitted, a second fit portion to which the center plate is fitted, and a third fit portion to which the fixation member is fitted. The center plate is interposed between the fixation member and a step surface between the first fit portion and the second fit portion so as not to allow axial movement of the center plate relative to the body member.

### INCORPORATION BY REFERENCE

The disclosure of Japanese Patent Application No. 2018-109742 filed on Jun. 7, 2018 including the specification, drawings and abstract, is incorporated herein by reference in its entirety.

### BACKGROUND OF THE INVENTION

### 1. Field of the Invention

The invention relates to a drive force distribution apparatus that distributes a drive force input from a drive source to a plurality of rotating output members.

### 2. Description of Related Art

Drive force distribution apparatuses for distributing a drive force input from a drive source to a plurality of rotating output members are used as vehicle differentials. Japanese Patent Application Publication No. 2006-182242 (JP 2006-182242 A) discloses a vehicle differential that includes multi-plate clutches having a plurality of clutch plates to adjust a drive force to be transmitted to rotating output members.

In the drive force distribution apparatus (a rear-wheel-axle differential mechanism) disclosed in JP 2006-182242 A, a drive force input to an input shaft is transmitted through a bevel gear pair to a hollow shaft (a supporting member) and is then transmitted from the shaft to a tubular clutch housing (a clutch guide). The shaft and the clutch housing are spline coupled together so as not to allow relative rotation therebetween. Within the clutch housing, right and left output members are mounted coaxially with each other, a right multi-plate clutch having a plurality of right input plates and right output plates is mounted between the clutch housing and the right output member, and a left multi-plate clutch having a plurality of left input plates and left output plates is mounted between the clutch housing and the left output member. Further, a center plate is mounted between the right multi-plate clutch and the left multi-plate clutch.

JP 2006-182242 A describes a first embodiment where the center plate is axially slidable on spline grooves formed in an inner circumferential surface of the clutch housing, and a second embodiment where the center plate is fixed to the clutch housing by a fixation member. According to the first embodiment, both the right and left multi-plate clutches are pressed by equal hydraulic pressure supplied from a common hydraulic pressure feeder so that an equal drive force is transmitted to both the right and left output members. According to the second embodiment, each of the right and left multi-plate clutches is pressed by hydraulic pressure supplied from a different hydraulic pressure feeder so that a drive force based on the hydraulic pressure is transmitted individually to each of the right and left output members. JP 2006-182242 A describes that the second embodiment enables independent control of a rotational drive force to be transmitted to each of right and left rear wheel axle shafts.

In the drive force distribution apparatus, to achieve independent control of the rotational drive force to be transmitted to each of the right and left wheel axle shafts as described in the second embodiment, the center plate is required to be fixed rigidly in axial position relative to the clutch housing. This is because if the center plate is moved axially relative to the clutch housing, the force pressing the right multi-plate clutch disadvantageously acts also on the left multi-plate clutch, and the force pressing the left multi-plate clutch disadvantageously acts also on the right multi-plate clutch.

One approach to firmly fix the center plate to the clutch housing may be to weld the center plate to the clutch housing. However, there are concerns with this approach. First, it is difficult for welding tools to reach the center plate because the center plate is located in an axially center portion of the clutch housing. Further, weld spatter or other foreign matter may be stuck to the inner surface of the clutch housing. Another approach may be to bolt the center plate to the clutch housing. However, this approach increases the number of necessary bolts, and accordingly, increases the number of parts and man hours for assembly, thus causing a cost increase.

### SUMMARY OF THE INVENTION

A purpose of the invention is to provide a drive force distribution apparatus that allows a center plate to be positioned with high rigidity in an axial position relative to a clutch housing while saving cost, so as to allow independent control of a drive force to be transmitted to each of rotating output members.

An aspect of the invention provides a drive force distribution apparatus including the following: a clutch housing that receives a drive force; a first multi-plate clutch located within the clutch housing; a second multi-plate clutch located within the clutch housing; a center plate that is located between the first multi-plate clutch and the second multi-plate clutch and that is not allowed to move axially relative to the clutch housing; a first pressing mechanism that presses the first multi-plate clutch toward the center plate; and a second pressing mechanism that presses the second multi-plate clutch toward the center plate. In the drive force distribution apparatus, the drive force is distributed through the first multi-plate clutch and the second multi-plate clutch. The clutch housing includes a bottomed cylindrical body member and a tubular fixation member. The body member includes a cylindrical portion and a bottom portion. The bottom portion is unitary with the cylindrical portion and extends radially inward from a first end of the cylindrical portion. The cylindrical portion is open at a second end opposite the first end. The fixation member is fixed to part of the cylindrical portion close to the second end. The first multi-plate clutch has first outer clutch plates and first inner clutch plates alternating with the first outer clutch plates. The second multi-plate clutch has second outer clutch plates and second inner clutch plates alternating with the second outer clutch plates. The first multi-plate clutch is located closer to the bottom portion of the body member than the second multi-plate clutch. The cylindrical portion of the body member includes a first fit portion to which the plurality of first outer clutch plates of the first multi-plate clutch are spline-fitted, a second fit portion to which the center plate is spline-fitted, and a third fit portion to which the fixation member is spline-fitted. Each of the second fit portion and the third fit portion is larger in inside diameter than the first fit portion. The second outer clutch plates of the second multi-plate clutch are spline-fitted to an inner circumference of the fixation member. The center plate is interposed between an axial end face of the fixation member and a step surface between the first fit portion and the second fit portion so as not to allow axial movement of the center plate relative to the body member.

According to the above aspect, the drive force distribution apparatus allows the center plate to be positioned with high rigidity in an axial direction relative to the clutch housing while saving cost, so as to allow independent control of the drive force to be transmitted to each of the rotating output members.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram schematically illustrating an example structure of a four-wheel drive vehicle equipped with a drive force distribution apparatus according to a first embodiment of the invention;

FIG. 2 is a horizontal cross-sectional view of the drive force distribution apparatus mounted on the four-wheel drive vehicle;

FIG. 3 is a cross-sectional view of a main portion of the drive force distribution apparatus;

FIG. 4A is a partially broken perspective view of a body member of a clutch housing, with circumferential part broken away;

FIG. 4B is a perspective view of the body member in FIG. 4A assembled with a fixation member, a center plate, and a first outer clutch plate;

FIG. 5 is a cross-sectional view of a second fit portion of a cylindrical portion and also illustrates a step surface between a first fit portion and the second fit portion;

FIG. 6A is a plan view of the first outer clutch plate;

FIG. 6B is a plan view of a second outer clutch plate;

FIG. 6C is a plan view of the center plate;

FIG. 6D illustrates a first axial end face of the fixation member;

FIGS. 7A to 7D are cross-sectional views respectively illustrating first to fourth steps in an assembly process;

FIG. 8A is a partially broken perspective view of a body member of a clutch housing, with circumferential part broken away, according to a second embodiment;

FIG. 8B is a perspective view of the body member in FIG. 8A assembled with a fixation member, a center plate, and a first outer clutch plate; and

FIGS. 9A to 9D are cross-sectional views respectively illustrating first to fourth steps in an assembly process according to the second embodiment.

### DETAILED DESCRIPTION OF EMBODIMENTS

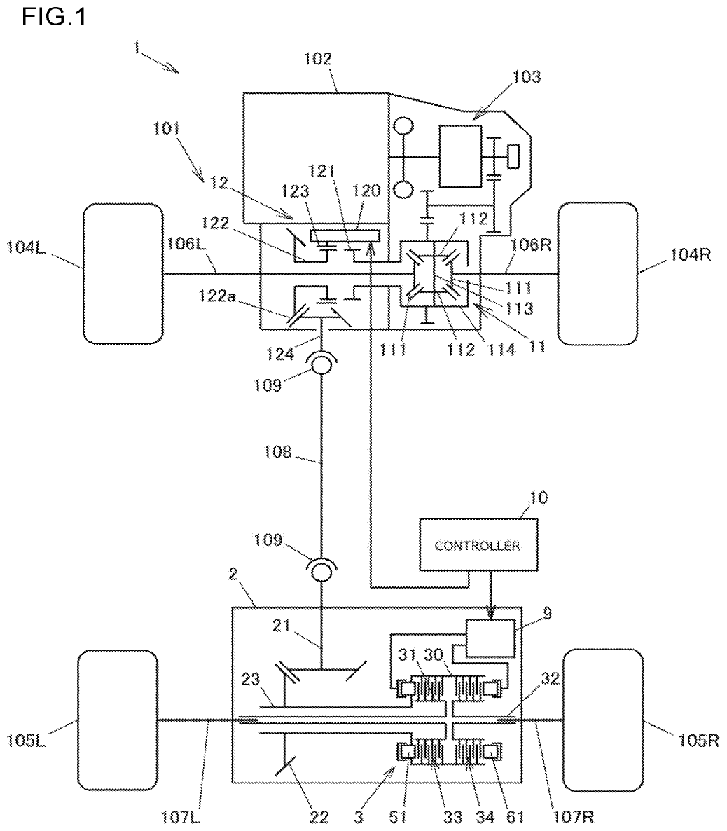

A first embodiment of the invention is described with reference to the drawings. FIG. 1 is a diagram schematically illustrating an example structure of a four-wheel drive vehicle 1 equipped with a drive force distribution apparatus 2 according to the first embodiment.

The four-wheel drive vehicle 1 includes the following: an engine 102 as a drive source for generating a drive force that the four-wheel drive vehicle 1 uses to travel; a transmission 103; right and left front wheels 104R and 104L as a pair of main drive wheels; right and left rear wheels 105R and 105L as a pair of auxiliary drive wheels; a drive force transmission system 101 that allows transmission of the drive force of the engine 102 to the front wheels 104R and 104L and to the rear wheels 105R and 105L; and a controller 10.

The four-wheel drive vehicle 1 is switchable between a four-wheel drive state and a two-wheel drive state. In the four-wheel drive state, the drive force of the engine 102 is transmitted to not only the front wheels 104R and 104L, but also the rear wheels 105R and 105L. In the two-wheel drive state, the drive force of the engine 102 is transmitted to only the front wheels 104R and 104L. Throughout the first embodiment, notations “R” and “L” in reference numerals are respectively used to denote the right side and the left side of the four-wheel drive vehicle 1.

The drive force transmission system 101 includes the following: a front differential 11; a propeller shaft 108 that serves as a drive shaft for transmitting the drive force of the engine 102 in a vehicle longitudinal direction; a dog clutch 12 that selectively interrupts the transmission of the drive force from the engine 102 to the propeller shaft 108; the drive force distribution apparatus 2 that variably distributes the drive force from the propeller shaft 108 to the rear wheels 105R and 105L; front drive shafts 106R and 106L; and rear drive shafts 107R and 107L. The drive force of the engine 102 is always transmitted to the front wheels 104R and 104L through the front drive shafts 106R and 106L. The drive force of the engine 102 is selectively transmitted to the rear wheels 105R and 105L through the dog clutch 12, the propeller shaft 108, the drive force distribution apparatus 2, and the rear drive shafts 107R and 107L.

The controller 10 controls the dog clutch 12 and the drive force distribution apparatus 2. When the four-wheel drive vehicle 1 is in the four-wheel drive state, the controller 10 controls the dog clutch 12 and the drive force distribution apparatus 2 to transmit the drive force to the rear wheels 105R and 105L. When the four-wheel drive vehicle 1 is in the two-wheel drive state, the controller 10 controls the dog clutch 12 and the drive force distribution apparatus 2 to interrupt the transmission of the drive force. Thus, in the two-wheel drive state, the propeller shaft 108 and other related elements stop rotating, so that fuel economy performance is improved accordingly.

The front differential 11 includes the following: a pair of side gears 111 each coupled to a corresponding one of the front drive shafts 106R and 106L; a pair of pinion gears 112 that mesh with the pair of side gears 111 with their gear axes perpendicular to each other; a pinion gear shaft 113 that supports the pair of pinion gears 112; and a front differential case 114 that houses the pair of side gears 111, the pair of pinion gears 112, and the pinion gear shaft 113. The transmission 103 transmits the drive force of the engine 102 to the front differential case 114 while changing the speed of the drive force, and the drive force transmitted to the front differential case 114 is output to the front drive shafts 106R and 106L.

The dog clutch 12 includes the following: a first rotating member 121 that rotates as a unit with the front differential case 114; a second rotating member 122 coaxially aligned with the first rotating member 121; a sleeve 123 that selectively couples the first rotating member 121 and the second rotating member 122 together such that the first rotating member 121 and the second rotating member 122 are not allowed to rotate relative to each other; and an actuator 120 that is controlled by the controller 10. The sleeve 123 is moved by the actuator 120 between two positions: a coupling position where the sleeve 123 meshes with both the first rotating member 121 and the second rotating member 122; and a decoupling position where the sleeve 123 meshes with only the second rotating member 122. When the sleeve 123 is in the coupling position, the first rotating member 121 and the second rotating member 122 are coupled together in a manner that does not allow relative rotation between the first rotating member 121 and the second rotating member 122. When the sleeve 123 is in the decoupling position, the first rotating member 121 and the second rotating member 122 are allowed to rotate relative to each other.

The propeller shaft 108 receives the drive force of the engine 102 from the front differential case 114 via the dog clutch 12 and transmits the drive force to the drive force distribution apparatus 2. Each end of the propeller shaft 108 is provided with a universal joint 109. One of the universal joints 109 that is attached to the front end of the propeller shaft 108 in the vehicle longitudinal direction couples the propeller shaft 108 to a pinion gear shaft 124 that meshes with a ring gear portion 122a provided on the second rotating member 122 of the dog clutch 12. The other of the universal joints 109 that is attached to the rear end of the propeller shaft 108 in the vehicle longitudinal direction couples the propeller shaft 108 to a pinion gear shaft 21 of the drive force distribution apparatus 2.

The drive force distribution apparatus 2 includes the following: the pinion gear shaft 21 that receives the drive force of the engine 102 from the propeller shaft 108; a ring gear 22 that rotates in mesh with the pinion gear shaft 21; a hollow shaft 23 that has a hollow cylindrical shape and that rotates as a unit with the ring gear 22; a clutch mechanism 3 that selectively transmits the drive force transmitted to the hollow shaft 23 to the rear drive shafts 107R and 107L; and a hydraulic unit 9 that supplies hydraulic oil to the clutch mechanism 3. The clutch mechanism 3 includes the following: a clutch housing 30 that rotates as a unit with the hollow shaft 23; and first and second clutch hubs 31 and 32 as first and second output members. The clutch mechanism 3 distributes the drive force from the pinion gear shaft 21 to the first and second clutch hubs 31 and 32, thereby outputting the drive force to the rear drive shafts 107R and 107L.

In the four-wheel drive state, the controller 10 controls the drive force distribution apparatus 2 such that larger drive force is transmitted to the rear wheels 105R and 105L, for example, as a differential rotational speed increases and as an accelerator pedal depression amount increases. The differential rotational speed is the difference between the average rotational speed of the front wheels 104R and 104L and the average rotational speed of the rear wheels 105R and 105L. The accelerator pedal depression amount is the amount by which a driver depresses an accelerator pedal. Further, for example, when the four-wheel drive vehicle 1 makes a turn, the controller 10 performs control to transmit more drive force to the outer one of the rear wheels 105R and 105L in the direction of the turn being made than to the inner one in order to enable the four-wheel drive vehicle 1 to turn smoothly. As another example, in the event of oversteer or understeer, the controller 10 performs stability control that stabilizes the traveling condition by adjusting the drive force to be transmitted to each of the rear wheels 105R and 105L.

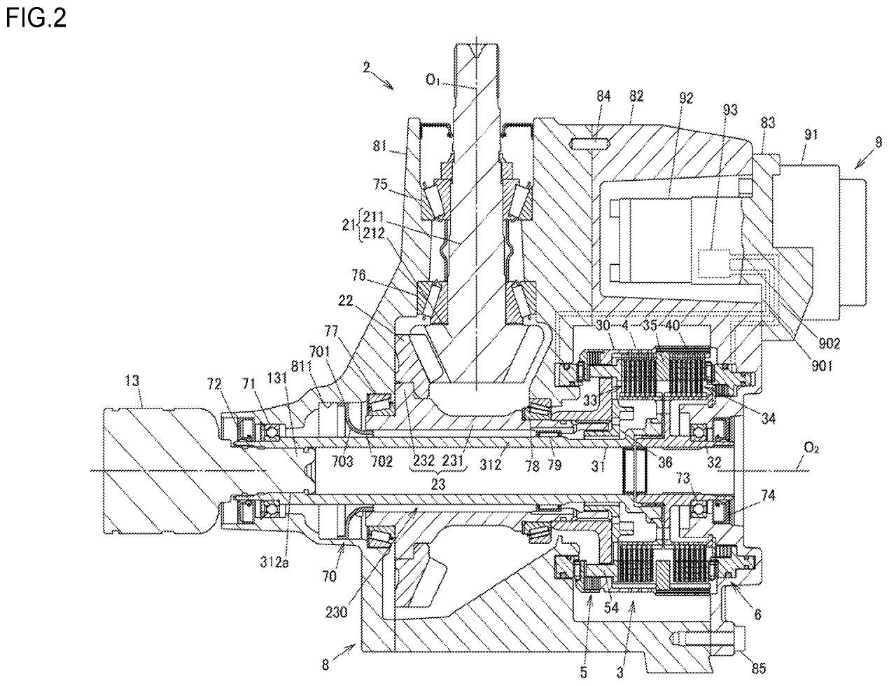

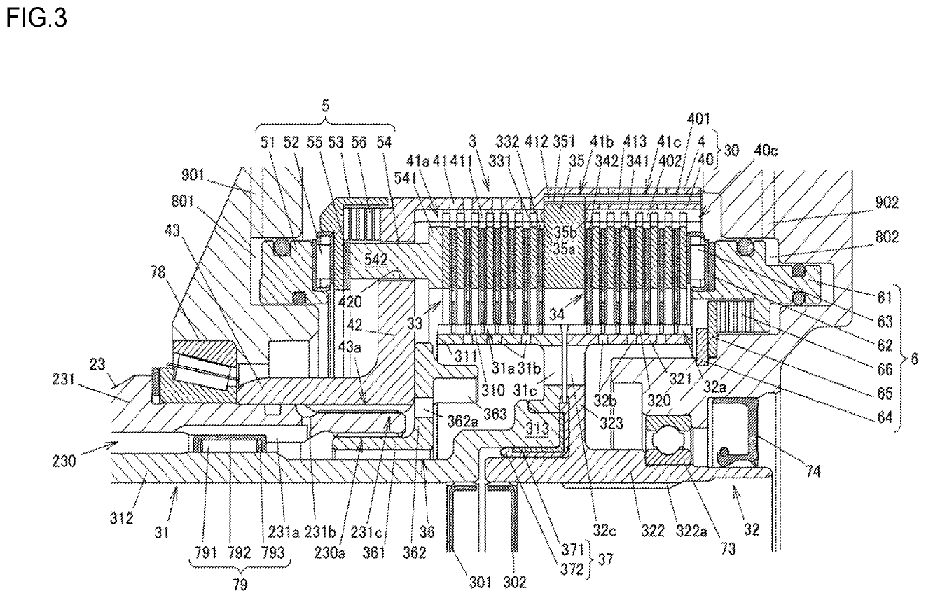

Next, the structure of the drive force distribution apparatus 2 is described in detail. FIG. 2 is a cross-sectional view of the whole of the drive force distribution apparatus 2. FIG. 3 is a cross-sectional view of a main portion of the drive force distribution apparatus 2.

The drive force distribution apparatus 2 has a case member 8 fixed to a vehicle body. The pinion gear shaft 21, the ring gear 22, the hollow shaft 23, and the clutch mechanism 3 are housed in the case member 8. The pinion gear shaft 21 rotates about a rotation axis O₁ that extends in the vehicle longitudinal direction. The ring gear 22 and the hollow shaft 23 rotate about a rotation axis O₂ that extends in a vehicle transverse direction. The terms “axial” and “axially” used hereinafter refer to directions parallel to the rotation axis O₂.

The case member 8 includes a case body 81, a case lid 82, and a support body 83 that supports the hydraulic unit 9. The case body 81 and the case lid 82 are joined together by a plurality of positioning pins 84 and bolts 85. FIG. 2 illustrates one of the positioning pins 84 and one of the positioning bolts 85. Lubricating oil (not illustrated) is sealed in the case member 8.

The clutch mechanism 3 includes the following: the clutch housing 30 that is not allowed to rotate relative to the hollow shaft 23; the first clutch hub 31 as a first rotating output member; the second clutch hub 32 as a second rotating output member; a first multi-plate clutch 33 located between the clutch housing 30 and the first clutch hub 31; a second multi-plate clutch 34 located between the clutch housing 30 and the second clutch hub 32; a center plate 35 located between the first multi-plate clutch 33 and the second multi-plate clutch 34; and a stopper ring 36 that serves as a stopper member to keep the clutch housing 30 from coming off the hollow shaft 23.

The first multi-plate clutch 33 and the second multi-plate clutch 34 are located within the clutch housing 30. In the clutch mechanism 3, a drive force (torque) is input to the clutch housing 30 from the hollow shaft 23, and the input drive force is distributed to the first clutch hub 31 and the second clutch hub 32 respectively through the first multi-plate clutch 33 and the second multi-plate clutch 34.

The clutch housing 30 includes a bottomed cylindrical body member 4 and a tubular fixation member 40 fixed to the body member 4. The body member 4 unitarily includes the following: a cylindrical portion 41; an annular bottom portion 42 extending radially inward from one end of the cylindrical portion 41; and a neck portion 43 projecting from an inner perimeter of the bottom portion 42 in a direction away from the cylindrical portion 41. A plurality of insertion holes 420 are formed in the bottom portion 42. The cylindrical portion 41 is open at the other end opposite the end provided with the bottom portion 42. The fixation member 40 is fixed to the body member 4 by being fitted in part of the opening of the cylindrical portion 41 of the body member 4.

The first multi-plate clutch 33 is located within the cylindrical portion 41 and is located closer to the bottom portion 42 than the second multi-plate clutch 34. The second multi-plate clutch 34 is located within the fixation member 40. The center plate 35 is located between the first multi-plate clutch 33 and the second multi-plate clutch 34 and is not allowed to move axially relative to the clutch housing 30.

The first multi-plate clutch 33 includes a plurality of first outer clutch plates 331 and a plurality of first inner clutch plates 332 that alternate with the first outer clutch plates 331. The second multi-plate clutch 34 includes a plurality of second outer clutch plates 341 and a plurality of second inner clutch plates 342 that alternate with the second outer clutch plates 341.

The first clutch hub 31 includes an outer cylindrical portion 311 radially facing the cylindrical portion 41 of the body member 4 of the clutch housing 30. The outer cylindrical portion 311 is provided with an outer spline-fit portion 31a having a plurality of spline projections 310 that engage the first outer clutch plates 331 in a manner that allows axial movement of the first outer clutch plates 331. The first clutch hub 31 further includes the following: an inner cylindrical portion 312 having an inner circumferential surface provided with an inner spline-fit portion 312a that fits on one end of the drive shaft 107L in a manner that does not allow relative rotation between the inner cylindrical portion 312 and the drive shaft 107L; and an end wall portion 313 located between respective ends of the outer cylindrical portion 311 and the inner cylindrical portion 312. FIG. 2 illustrates an outer race 13 of a constant-velocity joint that is part of the drive shaft 107L. A stem portion 131 of the outer race 13 fits in the inner spline-fit portion 312a.

The second clutch hub 32 includes an outer cylindrical portion 321 radially facing the fixation member 40 of the clutch housing 30. The outer cylindrical portion 321 is provided with an outer spline-fit portion 32a having a plurality of spline projections 320 that engage the second inner clutch plates 342 in a manner that allows axial movement of the second inner clutch plates 342. The second clutch hub 32 further includes the following: an inner cylindrical portion 322 having an inner circumferential surface provided with an inner spline-fit portion 322a that fits on one end of the drive shaft 107R in a manner that does not allow relative rotation between the inner cylindrical portion 322 and the drive shaft 107R; and an end wall portion 323 located between respective ends of the outer cylindrical portion 321 and the inner cylindrical portion 322.

According to the first embodiment, the first clutch hub 31 includes two members, and the two members are integrated together into the first clutch hub 31 by being welded to the end wall portion 313. Alternatively, the first clutch hub 31 may have a unitary structure formed from one member. According to the first embodiment, the second clutch hub 32 has a unitary structure formed from one member. Alternatively, the second clutch hub 32 may include a plurality of members that are integrated together into the second clutch hub 32 by welding or any other suitable method.

An end cap 301 is attached to the inner cylindrical portion 312 of the first clutch hub 31 to prevent leakage of the lubricating oil. An end cap 302 is attached to the inner cylindrical portion 322 of the second clutch hub 32 to prevent leakage of the lubricating oil. A ball bearing 71 and a sealing member 72 are located between an outer circumferential surface of the inner cylindrical portion 312 of the first clutch hub 31 and an inner surface of an opening of the case body 81. A ball bearing 73 and a sealing member 74 are located between an outer circumferential surface of the inner cylindrical portion 322 of the second clutch hub 32 and an inner surface of an opening of the case lid 82. A bush 37 is attached to the end wall portion 313 of the first clutch hub 31 to smooth relative rotation between the first clutch hub 31 and the second clutch hub 32. The bush 37 includes a core 371 having an L-shaped cross section, and a resin portion 372 covering the core 371.

The outer cylindrical portion 311 of the first clutch hub 31 has a plurality of oil holes 31b formed therein for circulating the lubricating oil. The outer cylindrical portion 321 of the second clutch hub 32 has a plurality of oil holes 32b formed therein for circulating the lubricating oil. The end wall portion 313 of the first clutch hub 31 has a plurality of oil holes 31c formed therein for circulating the lubricating oil. The end wall portion 323 of the second clutch hub 32 has a plurality of oil holes 32c formed therein for circulating the lubricating oil.

The body member 4 of the clutch housing 30 has an inner circumferential surface provided with a first fit portion 41a having a plurality of first spline projections 411 that engage the first outer clutch plates 331 in a manner that allows axial movement of the first outer clutch plates 331. The first fit portion 41a is located closer to the bottom portion 42 than the center plate 35. The fixation member 40 has an inner circumferential surface provided with a fit portion 40c having a plurality of spline projections 402 that engage the second outer clutch plates 341 in a manner that allows axial movement of the second outer clutch plates 341. Details of the structures of the body member 4 and the fixation member 40 of the clutch housing 30 are described later.

The first multi-plate clutch 33 transmits the drive force between the clutch housing 30 and the first clutch hub 31 by frictional force acting between the first outer clutch plates 331 and the first inner clutch plates 332. The second multi-plate clutch 34 transmits the drive force between the clutch housing 30 and the second clutch hub 32 by frictional force acting between the second outer clutch plates 341 and the second inner clutch plates 342.

The drive force distribution apparatus 2 further includes a first pressing mechanism 5 and a second pressing mechanism 6. The first pressing mechanism 5 presses the first multi-plate clutch 33 toward the center plate 35, thereby frictionally contacting the first outer clutch plates 331 and the first inner clutch plates 332 with each other. The second pressing mechanism 6 presses the second multi-plate clutch 34 toward the center plate 35, thereby frictionally contacting the second outer clutch plates 341 and second inner clutch plates 342 with each other.

The first pressing mechanism 5 includes the following: a first piston 51 that receives hydraulic pressure supplied through a first oil passage 901 from the hydraulic unit 9 to a first cylinder 801 formed in the case body 81; a thrust roller bearing 52 in abutment with the first piston 51; an annular pressure receiver 53 that is located relative to the first piston 51 to interpose the thrust roller bearing 52 therebetween; a pressing member 54 that presses the first multi-plate clutch 33; a thrust washer 55 interposed between the pressure receiver 53 and the pressing member 54; and a return spring 56 located and compressed between the bottom portion 42 of the body member 4 of the clutch housing 30 and the pressure receiver 53.

The pressing member 54 unitarily includes the following: an annular pressing portion 541 located between the bottom portion 42 of the body member 4 of the clutch housing 30 and the first multi-plate clutch 33; and a plurality of leg portions 542 each inserted through a corresponding one of the insertion holes 420 in the bottom portion 42. The insertion of the leg portions 542 through the insertion holes 420 does not allow rotation of the pressing member 54 relative to the clutch housing 30.

The second pressing mechanism 6 includes the following: a second piston 61 that receives hydraulic pressure supplied through a second oil passage 902 from the hydraulic unit 9 to a second cylinder 802 formed in the case lid 82; a thrust washer 62 and a thrust roller bearing 63 that are located between the second piston 61 and the second multi-plate clutch 34; a snap ring 64 fitted to the case lid 82; a washer 65 in abutment with the snap ring 64; and a return spring 66 located and compressed between the washer 65 and the second piston 61.

As illustrated in FIG. 2, the pinion gear shaft 21 has a shank 211 supported by a pair of tapered roller bearings 75 and 76, and a gear portion 212 provided at one end of the shank 211. The other end of the shank 211 is coupled to the universal joint 109 that is attached to the rear end of the propeller shaft 108. The gear portion 212 of the pinion gear shaft 21 and the ring gear 22 in mesh with the gear portion 212 may be, for example, a hypoid gear set.

The hollow shaft 23 unitarily includes a cylindrical shank 231 and a flange 232 to which the ring gear 22 is attached. The flange 232 projects radially outward from the shank 231 and is fixed, for example, welded to the ring gear 22 so as to allow the hollow shaft 23 to rotate as a unit with the ring gear 22. The hollow shaft 23 has a hollow portion 230 in the center of the shank 231, and the inner cylindrical portion 312 of the first clutch hub 31 is inserted through the hollow portion 230. An inner circumferential surface of one end of the hollow portion 230 is provided with a helical screw groove that forms a screw hole 230a.

A funnel-shaped, lubricating-oil introduction member 70 is located around the inner cylindrical portion 312 of the first clutch hub 31. The lubricating-oil introduction member 70 unitarily includes the following: a cylindrical base end 701 press-fitted in a fitting hole 811 that is formed in the case body 81; a cylindrical tip end 702 inserted in the hollow portion 230 of the hollow shaft 23; and an inclined portion 703 that decreases in diameter from the cylindrical base end 701 to the cylindrical tip end 702. An outer circumferential surface of the cylindrical tip end 702 faces an inner circumferential surface of the hollow portion 230 with a slight clearance therebetween. An inner circumferential surface of the cylindrical tip end 702 faces the outer circumferential surface of the inner cylindrical portion 312 of the first clutch hub 31 with a clearance therebetween that is greater than the clearance between the outer circumferential surface of the cylindrical tip end 702 and the inner circumferential surface of the hollow portion 230. The lubricating oil scooped up by the ring gear 22 is supplied through an oil passage (not illustrated) into the fitting hole 811 on the same side of the lubricating-oil introduction member 70 as the ball bearing 71 (i.e., on the opposite side of the lubricating-oil introduction member 70 from the hollow shaft 23). The lubricating-oil introduction member 70 introduces the lubricating oil into the hollow portion 230 of the hollow shaft 23.

The hollow shaft 23 is supported within the case member 8 by a pair of tapered roller bearings 77 and 78. A radial roller bearing 79 is located between an inner circumferential surface of the hollow shaft 23 and the inner cylindrical portion 312 of the first clutch hub 31. The radial roller bearing 79 includes a plurality of rollers 791, a shell 792 having an inner circumferential surface where the rollers 791 roll, and a cage 793 that holds the rollers 791. An oil groove 231a is formed in the inner circumferential surface of the hollow shaft 23 to axially flow the lubricating oil introduced in the hollow portion 230. The oil groove 231a is located around the shell 792. The hollow shaft 23 has a through hole 231b radially extending therethrough and communicating with the oil groove 231a.

An outer circumferential surface of the shank 231 of the hollow shaft 23 at an end toward the clutch mechanism 3 is provided with an outer engagement portion 231c that couples the shank 231 to the body member 4 of the clutch housing 30 in a manner that does not allow relative rotation between the hollow shaft 23 and the clutch housing 30. The neck portion 43 of the body member 4 has an inner circumferential surface provided with an inner engagement portion 43a that circumferentially engages the outer engagement portion 231c. Spline projections are formed in each of the outer engagement portion 231c and the inner engagement portion 43a, and the spline projections are absent along part of their circumferences to provide a missing tooth section. The missing tooth section allows the lubricating oil supplied through the through hole 231b in the hollow shaft 23 to flow therethrough toward the stopper ring 36.

The stopper ring 36 includes the following: an external thread portion 361 that threadedly engages in the screw hole 230a of the hollow shaft 23; an opposed wall 362 that projects radially outward beyond the outer circumferential surface of the hollow shaft 23 and that axially faces the bottom portion 42 of the body member 4 of the clutch housing 30; and a canopy portion 363 axially projecting from the opposed wall 362. An oil hole 362a is formed in the opposed wall 362 to allow the lubricating oil supplied through the missing tooth section to flow therethrough. The lubricating oil flowing out of the oil hole 362a is guided by the canopy portion 363 and is then splashed from the tip of the canopy portion 363 into the outer cylindrical portion 311 of the first clutch hub 31 by centrifugal force. The splashed lubricating oil is supplied to the first and second multi-plate clutches 33 and 34 through the oil holes 31b, 32b, 31c, and 32c.

The hydraulic unit 9 includes the following: an electric motor 91 that generates torque corresponding to a motor current output from the controller 10; a hydraulic pump 92 that is actuated by the electric motor 91; and a hydraulic circuit 93 that supplies hydraulic oil discharged from the hydraulic pump 92 to first and second oil passages 901 and 902. The hydraulic circuit 93 includes a control valve (not illustrated) that changes the degree of valve opening in accordance with a control current output from the controller 10. Each of the first and second oil passages 901 and 902 includes holes that are drilled in the case body 81, the case lid 82, and the support body 83.

The controller 10 outputs the motor current and the control current in such a manner as to supply the first and second oil passages 901 and 902 with hydraulic oil of pressure appropriate to the traveling condition of the four-wheel drive vehicle 1. For example, when the four-wheel drive vehicle 1 turns right, the pressure of hydraulic oil supplied to the first oil passage 901 is increased so as to increase the drive force transmitted from the first multi-plate clutch 33 to the first clutch hub 31. When the four-wheel drive vehicle 1 turns left, the pressure of hydraulic oil supplied to the second oil passage 902 is increased so as to increase the drive force transmitted from the second multi-plate clutch 34 to the second clutch hub 32. As another example, when a driver performs an operation to select the four-wheel drive mode, the pressure of hydraulic oil supplied to each of the first and second oil passages 901 and 902 is increased so as to bring the four-wheel drive vehicle 1 into the four-wheel drive state.

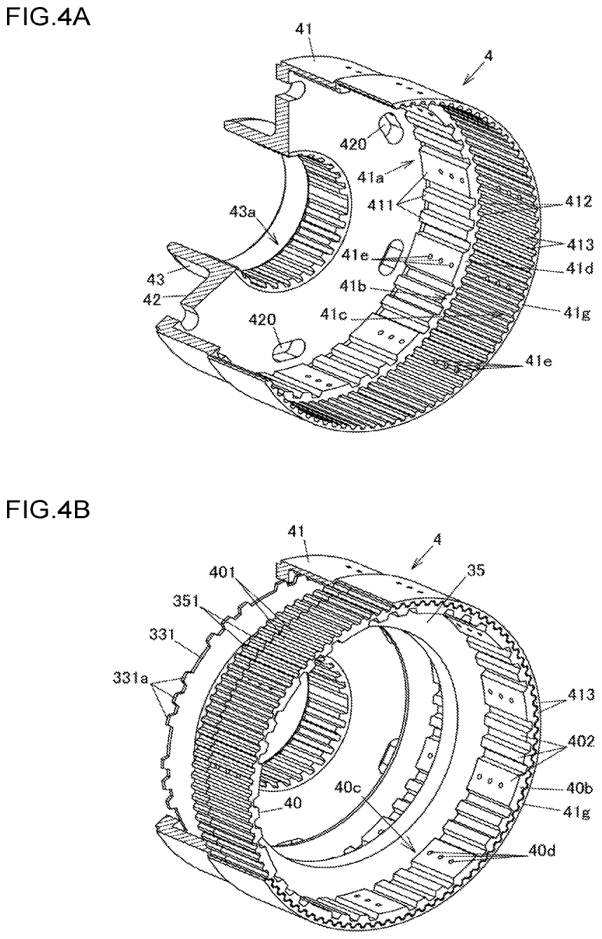

FIG. 4A is a partially broken perspective view of the body member 4 of the clutch housing 30, with circumferential part broken away. FIG. 4B is a perspective view of the body member 4 in FIG. 4A assembled with the fixation member 40, the center plate 35, and one of the first outer clutch plates 331.

As already described, the clutch housing 30 is assembled from the body member 4 and the fixation member 40. The inner circumferential surface of the cylindrical portion 41 of the body member 4 has the following: the first fit portion 41a to which the first outer clutch plates 331 of the first multi-plate clutch 33 are spline-fitted; a second fit portion 41b to which the center plate 35 is fitted in a manner that does not allow relative rotation between the body member 4 and the center plate 35; and a third fit portion 41c to which the fixation member 40 is fitted in a manner that does not allow relative rotation between the body member 4 and the fixation member 40. The second fit portion 41b and the third fit portion 41c are each larger in inside diameter than the first fit portion 41a. The difference in inside diameter between the first fit portion 41a and the second fit portion 41b forms a step surface 41d therebetween. According to the first embodiment, the second fit portion 41b and the third fit portion 41c have an equal inside diameter.

As already described, the first fit portion 41a has the first spline projections 411 that engage the first outer clutch plates 331. The second fit portion 41b has a plurality of second spline projections 412 that engage the center plate 35. The third fit portion 41c has a plurality of third spline projections 413 that engage the fixation member 40.

According to the first embodiment, each of the second spline projections 412 connects to a corresponding one of the third spline projections 413 to form a continuous spline projection. A portion of the continuous spline projection engages the center plate 35 and serves as the second spline projection 412. On the other hand, the remainder of the continuous spline projection engages the fixation member 40 and serves as the third spline projection 413. The pitch diameter of the set of second spline projections 412 in the second fit portion 41b and the pitch diameter of the set of third spline projections 413 in the third fit portion 41c are each larger than the pitch diameter of the set of first spline projections 411 in the first fit portion 41a.

The first to third spline projections 411, 412, and 413 are formed in the inner circumferential surface of the cylindrical portion 41 of the body member 4 and extend axially. The first spline projections 411 have different widths in the circumferential direction of the cylindrical portion 41 and are arranged in such a pattern that two narrower ones of the first spline projections 411 are located between wider ones of the first spline projections 411. Each of the second and third spline projections 412 and 413 has an equal width in the circumferential direction of the cylindrical portion 41. A plurality of oil holes 41e radially penetrating the cylindrical portion 41 are formed in the first fit portion 41a and the third fit portion 41c.

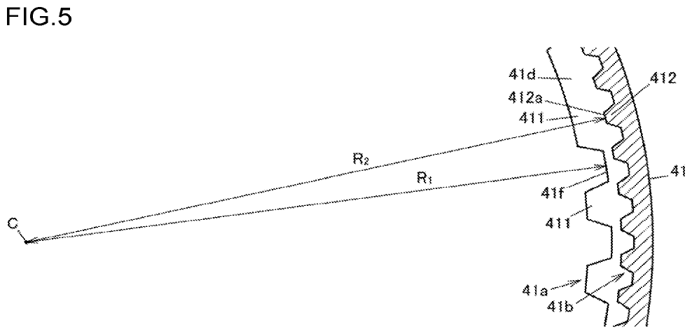

FIG. 5 is a cross-sectional view of the second fit portion 41b of the cylindrical portion 41 and also illustrates the step surface 41d between the first fit portion 41a and the second fit portion 41b. As illustrated in FIG. 5, a distance R₂ from a central axis C of the clutch housing 30 (coincident with the rotation axis O₂) to a top land 412a of any of the second spline projections 412 is greater than a distance R₁ from the central axis C to an inner circumferential surface 41f of the cylindrical portion 41 between circumferentially adjacent ones of the first spline projections 411 of the first fit portion 41a. Thus, the step surface 41d is formed along the entire circumference of the cylindrical portion 41. The step surface 41d is perpendicular to the axial direction and is oriented toward the opening of the cylindrical portion 41.

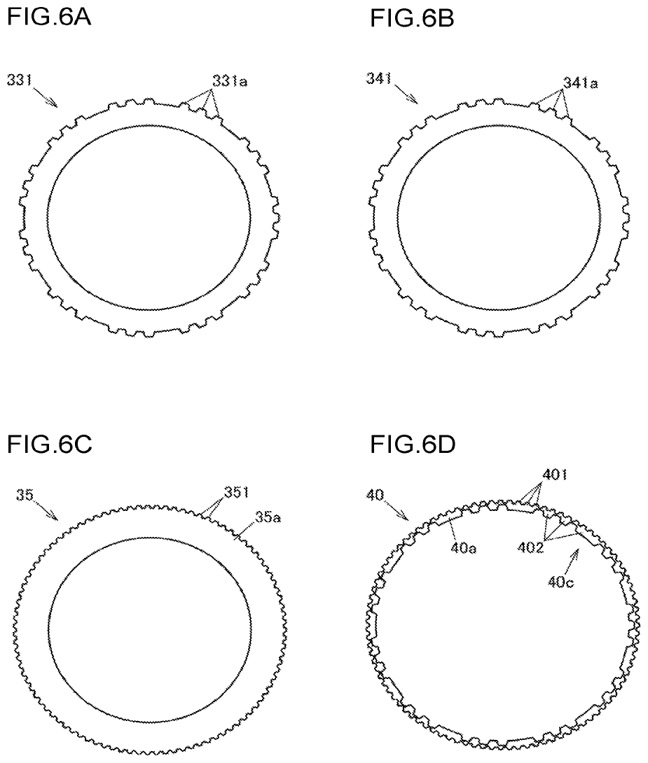

FIG. 6A is a plan view of the first outer clutch plate 331. FIG. 6B is a plan view of the second outer clutch plate 341. FIG. 6C is a plan view of the center plate 35. FIG. 6D illustrates a first axial end face 40a of the fixation member 40. The fixation member 40 has the first axial end face 40a at one axial end and a second axial end face 40b (refer to FIG. 4B) at the other axial end. The first axial end face 40a abuts with the center plate 35. The second axial end face 40b is an annular flat surface axially flush with an opening end face 41g of the cylindrical portion 41 of the body member 4.

Each of the first outer clutch plates 331 has an outer circumference provided with a plurality of projections 331a that engage the first spline projections 411, and the first outer clutch plates 331 are spline-fitted to the first fit portion 41a of the body member 4. The first outer clutch plates 331 are movable axially but are not rotatable, relative to the cylindrical portion 41 of the body member 4.

The center plate 35 has an outer circumference provided with a plurality of spline projections 351 that engage the second spline projections 412, and the center plate 35 is spline-fitted to the second fit portion 41b of the body member 4. The spline projections 351 engage the second spline projections 412 in the circumferential direction of the cylindrical portion 41, and thus the center plate 35 is not allowed to rotate relative to the body member 4. Further, the center plate 35 is interposed between the step surface 41d of the cylindrical portion 41 and the first axial end face 40a of the fixation member 40 so as not to allow axial movement of the center plate 35 relative to the body member 4.

A plurality of outer spline projections 401 are formed in the outer circumferential surface of the fixation member 40 and engage the third spline projections 413 of the body member 4. The inner circumferential surface of the fixation member 40 has the fit portion 40c to which the second outer clutch plates 341 of the second multi-plate clutch 34 are spline-fitted. A plurality of inner spline projections 402 extending axially are formed in the fit portion 40c and engage the second outer clutch plates 341. The pitch diameter of the spline projections 402 in the fit portion 40c is equal to the pitch diameter of the first spline projections 411 in the first fit portion 41a of the cylindrical portion 41.

Each of the second outer clutch plates 341 has an outer circumference provided with a plurality of projections 341a that engage the inner spline projections 402 of the fixation member 40, and the second outer clutch plates 341 are spline-fitted to the fit portion 40c of the fixation member 40. The second outer clutch plates 341 are movable axially but are not rotatable, relative to the fixation member 40. Since the pitch diameter in the fit portion 40c of the fixation member 40 is equal to the pitch diameter in the first fit portion 41a of the cylindrical portion 41, clutch plates used for the first outer clutch plates 331 can be used also for the second outer clutch plates 341.

The outer spline projections 401 of the fixation member 40 engage the third spline projections 413 of the cylindrical portion 41, and thus the fixation member 40 is not allowed to rotate relative to the body member 4. Further, according to the first embodiment, the fixation member 40 is fixed to the body member 4 by being press-fitted to the third fit portion 41c of the cylindrical portion 41. Specifically, the outer spline projections 401 of the fixation member 40 have a predetermined lead angle and are slightly inclined with respect to the axial direction accordingly. By virtue of the lead angle, the load required to fit the fixation member 40 to the third fit portion 41c by inserting the fixation member 40 from the opening of the cylindrical portion 41 gradually increases with the depth of insertion. Thus, the fixation member 40 is press-fitted to the third fit portion 41c.

The fixation member 40 is press-fitted by being inserted until the center plate 35 abuts with the first axial end face 40a of the fixation member 40 and is interposed between the step surface 41d of the cylindrical portion 41 and the first axial end face 40a. A first axial end face 35a of the center plate 35 abuts with the step surface 41d of the cylindrical portion 41 without clearance, and a second axial end face 35b of the center plate 35, opposite the first axial end face 35a, abuts with the first axial end face 40a of the fixation member 40 without clearance. As described above, the step surface 41d is formed along the entire circumference of the cylindrical portion 41 such that the distance R₂ is greater than the distance R₁. This structure provides an adequate area of contact between the center plate 35 and the step surface 41d so as not to exert excessive pressure on the step surface 41d.

The load required to press-fit the fixation member 40 to the third fit portion 41c of the cylindrical portion 41 is greater than a pressing load by which the pressing member 54 of the first pressing mechanism 5 presses the first multi-plate clutch 33. Thus, when the pressing member 54 presses the first multi-plate clutch 33, neither the center plate 35 nor the fixation member 40 is axially moved relative to the body member 4 by the pressing load.

The fixation member 40 has a plurality of oil holes 40d that axially penetrate the fixation member 40. The fixation member 40 is press-fitted to the third fit portion 41c such that the oil holes 40d communicate with the oil holes 41e in the third fit portion 41c of the cylindrical portion 41.

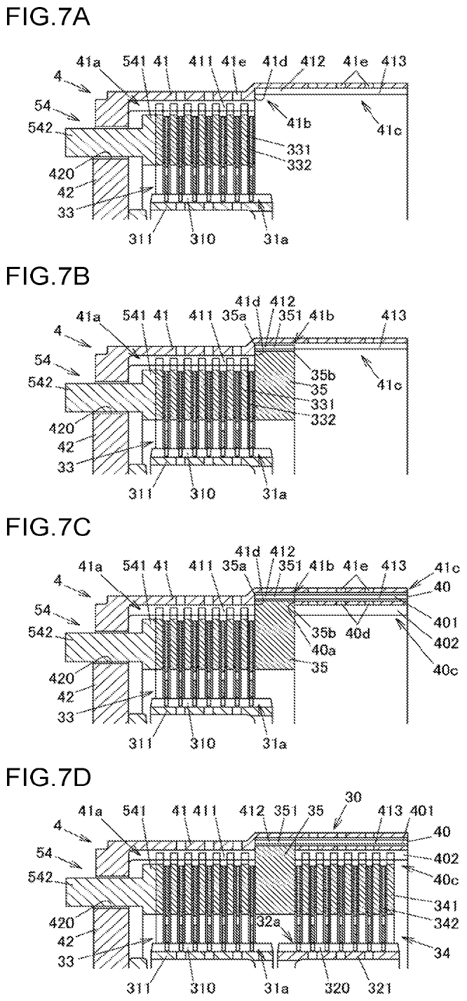

Next, steps in a process of assembling the clutch mechanism 3 are described with reference to FIGS. 7A to 7D. FIGS. 7A to 7D are cross-sectional views respectively illustrating the first to fourth steps in the assembly process. It is assumed here that the body member 4 is already mounted to the hollow shaft 23 by the stopper ring 36. Preferably, the opening of the cylindrical portion 41 face vertically upward during the assembly process.

In the first step illustrated in FIG. 7A, the pressing member 54 is assembled to the body member 4 by inserting the leg portions 542 through the insertion holes 420 of the bottom portion 42, and the outer cylindrical portion 311 of the first clutch hub 31 is mounted within the first clutch hub 31. Then, the first multi-plate clutch 33 is assembled by alternately placing the first outer clutch plates 331 and the first inner clutch plates 332.

In the second step illustrated in FIG. 7B, the center plate 35 is fitted to the second fit portion 41b of the body member 4 until the first axial end face 35a of the center plate 35 comes into abutment with the step surface 41d.

In the third step illustrated in FIG. 7C, the fixation member 40 is press-fitted to the third fit portion 41c of the cylindrical portion 41 until the first axial end face 40a of the fixation member 40 comes into abutment with the second axial end face 35b of the center plate 35. Thus, the center plate 35 is fixed by the fixation member 40 and is not allowed to move axially relative to the body member 4.

In the fourth step illustrated in FIG. 7D, the second clutch hub 32 is mounted within the fixation member 40, and the second multi-plate clutch 34 is assembled by alternately placing the second outer clutch plates 341 and the second inner clutch plates 342 between the fixation member 40 and the outer cylindrical portion 321 of the second clutch hub 32.

After that, the case lid 82 that is already assembled with the second pressing mechanism 6 is joined to the case body 81 by the positioning pins 84 and bolts 85, and the hydraulic unit 9 is assembled by the support body 83, thus completing the drive force distribution apparatus 2.

According to the assembly process described above, the fixation member 40 is fixed to the body member 4 by being press-fitted to the third fit portion 41c. Alternatively, the fixation member 40 may be fixed to the body member 4 by being welded to the open end of the cylindrical portion 41. In this case, the second axial end face 40b of the fixation member 40 may be welded to the opening end face 41g of the cylindrical portion 41 with the fixation member 40 pressed against the center plate 35. Preferably, a cap-shaped jig may be used to cover the opening of the fixation member 40 during the welding process to prevent entry of weld spatter or other foreign matter into the fixation member 40. When welding is used to fix the fixation member 40 to the body member 4, the outer spline projections 401 are not required to have a lead angle.

According to the first embodiment described above, the center plate 35 is interposed between the step surface 41d of the cylindrical portion 41 of the body member 4 and the fixation member 40. This structure restricts axial movement of the center plate 35 relative to the clutch housing 30 without fixing the center plate 35 to the body member 4 using welding or bolts. Thus, this structure allows the center plate 35 to be positioned with high rigidity in the axial direction relative to the clutch housing 30 while saving cost, so as to allow independent control of the drive force to be transmitted to each of the first and second clutch hubs 31 and 32. The body member 4 and the fixation member 40 can be formed easily by, for example, broaching or flow forming in which a workpiece is plastically deformed between a mandrel and a forming roller.

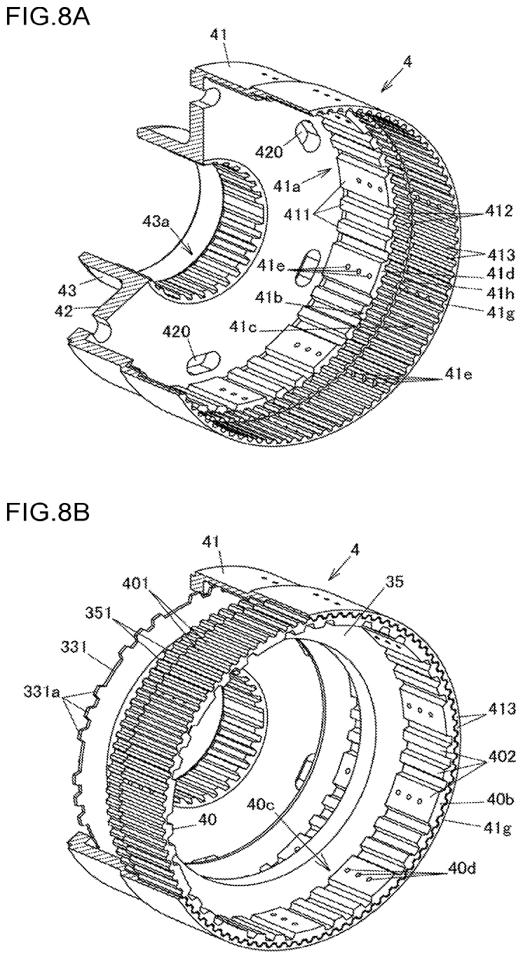

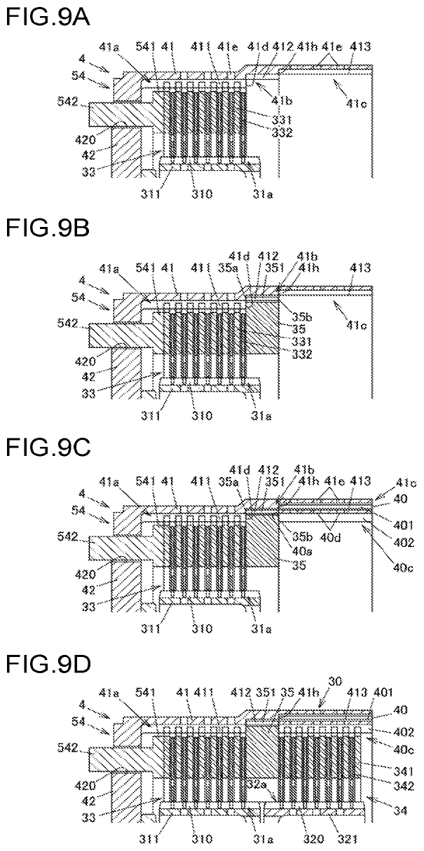

Next, a second embodiment of the invention is described with reference to FIGS. 8A and 8B, and FIGS. 9A to 9D. In FIGS. 8A and 8B, and FIGS. 9A to 9D, elements common between the first and second embodiments are denoted by the same reference symbols as those used in the drawings of the first embodiment, and the already described features of the common elements are not described in the second embodiment.

FIG. 8A is a partially broken perspective view of a body member 4 of a clutch housing 30 with circumferential part broken away, according to the second embodiment. FIG. 8B is a perspective view of the body member 4 in FIG. 8A assembled with a fixation member 40, a center plate 35, and one of the first outer clutch plates 331. FIGS. 9A to 9D are cross-sectional views respectively illustrating first to fourth steps in a process of assembling a clutch mechanism 3 including the clutch housing 30 according to the second embodiment.

According to the first embodiment, the second fit portion 41b and the third fit portion 41c of the cylindrical portion 41 of the body member 4 have an equal inside diameter. In contrast, according to the second embodiment, a second fit portion 41b is greater in inside diameter than a first fit portion 41a, and a third fit portion 41c is greater in inside diameter than the second fit portion 41b. The difference in inside diameter between the second fit portion 41b and the third fit portion 41c forms a step surface 41h therebetween.

The clutch mechanism 3 having the clutch housing 30 according to the second embodiment is assembled in the same manner as that according to the first embodiment. However, it is preferable that as illustrated in FIG. 9C, the fixation member 40 be fitted to the third fit portion 41c with a slight clearance left between the step surface 41h and a first axial end face 40a of the fixation member 40. This structure ensures that the first axial end face 40a of the fixation member 40 abuts with a second axial end face 35b of the center plate 35.

The second embodiment has the same features and advantages as the first embodiment. In addition, since the third fit portion 41c is greater in inside diameter than the second fit portion 41b, it is possible to increase the thickness of the fixation member 40 in order to increase the stiffness of the fixation member 40.

The embodiments described above may be modified in various ways within the scope of the invention. For example, although the embodiments describe that the first and second multi-plate clutches 33 and 34 are pressed by the first and second pistons 51 and 61 that receive hydraulic pressures, any other suitable structure may be used, such as a cam mechanism that converts a rotational force of an electric motor to axial cam thrust forces that press the first and second multi-plate clutches 33 and 34. The structure of the four-wheel drive vehicle 1 is not limited to the example illustrated in FIG. 1.

What is claimed is:

1. A drive force distribution apparatus comprising:
a clutch housing that receives a drive force;
a first multi-plate clutch located within the clutch housing;
a second multi-plate clutch located within the clutch housing;
a center plate that is located between the first multi-plate clutch and the second multi-plate clutch and that is not allowed to move axially relative to the clutch housing;
a first pressing mechanism that presses the first multi-plate clutch toward the center plate; and
a second pressing mechanism that presses the second multi-plate clutch toward the center plate, wherein
the drive force is distributed through the first multi-plate clutch and the second multi-plate clutch,
the clutch housing includes a bottomed cylindrical body member and a tubular fixation member, the body member including a cylindrical portion and a bottom portion, the bottom portion being unitary with the cylindrical portion and extending radially inward from a first end of the cylindrical portion, the cylindrical portion being open at a second end opposite the first end, the fixation member being fixed to part of the cylindrical portion close to the second end,
the first multi-plate clutch has a plurality of first outer clutch plates and a plurality of first inner clutch plates alternating with the plurality of first outer clutch plates,
the second multi-plate clutch has a plurality of second outer clutch plates and a plurality of second inner clutch plates alternating with the plurality of second outer clutch plates,
the first multi-plate clutch is located closer to the bottom portion of the body member than the second multi-plate clutch,
the cylindrical portion of the body member includes a first fit portion to which the plurality of first outer clutch plates of the first multi-plate clutch are spline-fitted, a second fit portion to which the center plate is spline-fitted, and a third fit portion to which the fixation member is spline-fitted,
each of the second fit portion and the third fit portion is larger in inside diameter than the first fit portion,
the plurality of second outer clutch plates of the second multi-plate clutch are spline-fitted to an inner circumference of the fixation member, and
the center plate is interposed between an axial end face of the fixation member and a step surface between the first fit portion and the second fit portion so as not to allow axial movement of the center plate relative to the body member.

2. The drive force distribution apparatus according to claim 1, wherein
the fixation member circumferentially engages the cylindrical portion of the body member so as not to allow rotation of the fixation member relative to the body member.

3. The drive force distribution apparatus according to claim 1, wherein
the center plate circumferentially engages the cylindrical portion of the body member so as not to allow rotation of the center plate relative to the body member.

4. The drive force distribution apparatus according to claim 1, wherein
the fixation member is fixed to the body member by being press-fitted to the third fit portion.

5. The drive force distribution apparatus according to claim 1, wherein
the fixation member is fixed to the body member by being welded to the second end of the cylindrical portion.

6. The drive force distribution apparatus according to claim 1, wherein
the third fit portion is greater in inside diameter than the second fit portion.
